(19) United States
(12) Patent Application Publication
(10) Pub. No.: US 2023/0241610 A1
(43) Pub. Date: Aug. 3, 2023

(54) Devices and Methods for Flow Control of Single Cells or Particles

(71) Applicant: TDK U.S.A. Corporation, Uniondale, NY (US)

(72) Inventors: Manish Giri, San Jose, CA (US); Rakesh Sethi, San Jose, CA (US); Vadim Piskun, San Jose, CA (US)

(73) Assignee: TDK U.S.A. Corporation, Uniondale, NY (US)

(21) Appl. No.: 17/589,591

(22) Filed: Jan. 31, 2022

(51) Int. Cl. B01L 3/00

(52) U.S. Cl. CPC B01L 3/502761; B01L 2200/027; B01L 2200/0652; B01L 2300/12; B01L 2400/0415

(57) ABSTRACT

A microfluidic device and a method for flow control of cells or particles in a microfluidic channel are disclosed. The microfluidic device may include a substrate with a microfluidic channel having at least one outlet; a first array of piezoelectric actuators located adjacent to the outlet for ejecting a portion of a fluid in the microfluidic channel; and one or more pairs of electrodes for charging particles (in the fluid) flowing through the microfluidic channel so that the particles can be manipulated with an electrical field.

### TECHNICAL FIELD

This application relates generally to flow control of cells or particles, and more particularly to flow control of cells or particles in a microfluidic flow channel.

### BACKGROUND

Conventional techniques for flow control of cells or particles in microfluidic devices rely on external flow systems (e.g., using components located outside the microfluidic device). However, such an external flow control system typically does not provide precise control of the flow dynamics in the microfluidic device for reliable cell capture, localization, and analysis, and results in a system that is more complex and less cost-effective. These and other challenges associated with external flow control systems have limited the throughput for processing cells or particles using a microfluidic device.

### SUMMARY

Devices and methods for flow control in microfluidic devices or systems are described herein. Such devices and methods may address challenges associated with conventional devices and methods for flow control in microfluidic devices or systems.

In accordance with some embodiments, a microfluidic device includes a substrate with a microfluidic channel having at least one outlet; a first array of piezoelectric actuators located adjacent to the outlet for ejecting a portion of a fluid in the microfluidic channel; and one or more pairs of electrodes for charging particles flowing through the microfluidic channel so that the particles can be manipulated with an electrical field.

In accordance with some embodiments, a method includes providing a plurality of particles through a microfluidic channel having an outlet; charging the particles flowing through the microfluidic channel so that the particles can be manipulated with an electrical field; and ejecting, with a first array of piezoelectric actuators located adjacent to the outlet, a portion of a fluid in the microfluidic channel.

Thus, the disclosed devices and methods relate to flow control techniques which are implemented within or as part of a microfluidic device, and allow controlling flow of cells or particles in a microfluidic flow channel based on electro-hydro-dynamic (EHD) displacement using piezoelectric actuators and electrodes. Such a controlled flow provides reliable cell capture, localization, and analysis. The disclosed devices and methods may replace, or complement, conventional devices and methods.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A shows a microfluidic device for flow control of cells or particles in a microfluidic channel in accordance with some embodiments.

FIG. 1B shows a microfluidic device for flow control of cells or particles in a microfluidic channel in accordance with some embodiments.

FIG. 2 shows a microfluidic device for flow control of cells or particles in a microfluidic channel in accordance with some embodiments.

FIG. 3 is a cross-sectional view of the output region of the microfluidic device shown in FIG. 2 in accordance with some embodiments.

FIG. 4 is a block diagram illustrating electrical components for flow control of cells or particles in a microfluidic channel in accordance with some embodiments.

FIG. 5 is a flow diagram illustrating a method of flow control of cells or particles in a microfluidic channel in accordance with some embodiments.

### DESCRIPTION OF EMBODIMENTS

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first array could be termed a second array, and, similarly, a second array could be termed a first array, without departing from the scope of the various described embodiments. The first array and the second array are both arrays, but they are not the same array.

The terminology used in the description of the embodiments herein is for the purpose of describing particular embodiments only and is not intended to be limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

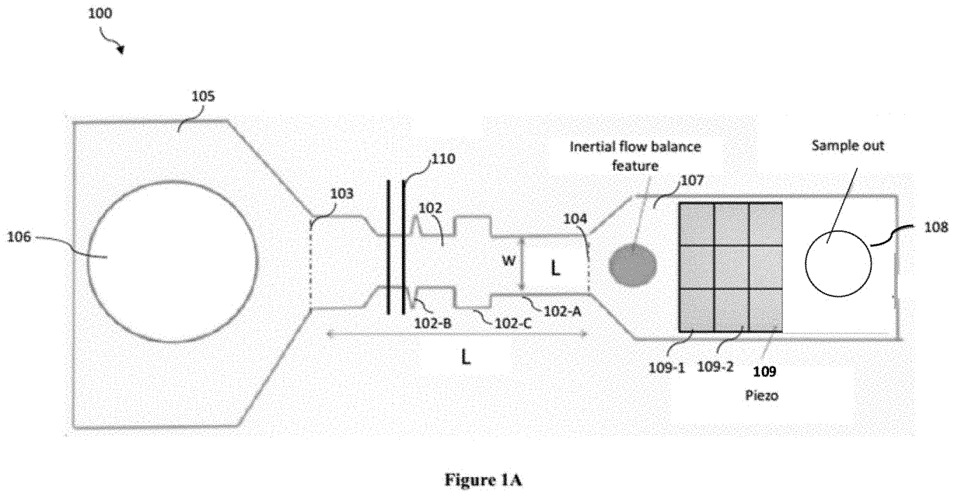

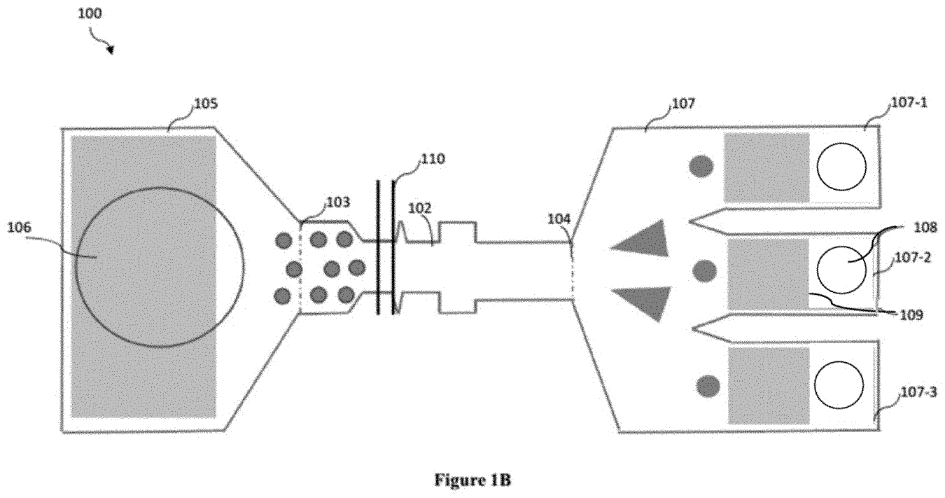

FIG. 1A shows a microfluidic device 100 in accordance with some embodiments. The device 100 includes a fluid channel 102 (e.g., a microfluidic channel) formed on a substrate. In some embodiments, the fluid channel 102 may be formed by coupling a first substrate with an indentation, recess, or notch with a second substrate so that the fluid channel 102 is defined between the first substrate and the second substrate.

The fluid channel 102 has an inlet 103 and an outlet 104, both of which are illustrated by dashed lines in FIG. 1A. The locations of the inlet 103 and the outlet 104 shown with respect to the fluid channel 102 in FIG. 1A are mere examples. The inlet 103 and the outlet 104 may be defined at any other location along the length dimension of the fluid channel 102 or the device 100. In some embodiments, the length of the fluid channel 102, L (e.g., measured from the inlet 103 to the outlet 104), is in the range of 1 mm to 50 mm. In some embodiments, a width W (e.g., a representative portion, such as 102-A, which may be the narrowest portion) of the fluid channel 102 may be configured based on the size of the particle to be analyzed. For example, for cellular measurements, the width W of the fluid channel 102 is configured in accordance with the size of the cell such that only a single cell is detected at a time. In some embodiments, the width W of the fluid channel 102 is in the range of 10 microns to 100 microns (e.g., 50 microns). In some embodiments, the fluid channel 102 includes one or more portions that have a width different from the width W. For example, as shown in FIG. 1A, the fluid channel 102 may include portions 102-B and 102-C having (protruding) shapes such that widths of the portions 102-B and 102-C are greater than the width W. Similarly, the fluid channel 102 may include one or more portions with widths narrower than the width W. In some embodiments, the wider the fluid channel 102 is, the slower is the velocity of the particles flowing in the corresponding portion of the fluid channel 102 (e.g., when the fluid channel 102 has a uniform height). As such, for example, the wider portion 102-C is used to reduce the velocity of the particles (e.g., immobilize the particles), which allows for more time for analyzing the particles.

The device 100 also includes an input region 105 for receiving at an inlet port 106 a sample fluid with particles (e.g., cells) as an input to the device 100 and providing the sample fluid from the inlet port 106 to the fluid channel 102 via the inlet 103. The device 100 further includes an output region 107 for collecting at least a portion of the sample fluid from the fluid channel 102 via the outlet 104 and ejecting or delivering the sample fluid portion via an outlet port 108 (e.g., a nozzle) for further processing or analysis. In some embodiments, the diameter of the outlet port 108 is in the range of 60 microns to 120 microns. In some embodiments, the fluid channel 102 is configured such that the inlet port 106 is the inlet 103 and the outlet port 108 is the outlet 104 of the fluid channel 102.

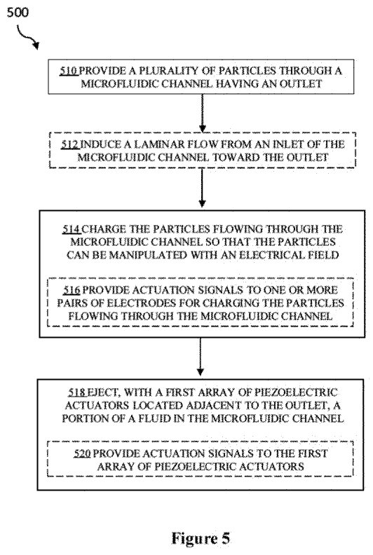

In some embodiments, the output region 107 includes a first array of piezoelectric actuators 109 located adjacent to the outlet 104 for ejecting a portion of the fluid in the fluid channel 102. In some embodiments, the first array of piezoelectric actuators 109 includes one or more piezoelectric actuators (e.g., a piezo micro-electro-mechanical system (MEMS) actuator). In some embodiments, the first array of piezoelectric actuators 109 includes two or more piezoelectric actuators (e.g., piezo actuators 109-1 and 109-2). In some embodiments, each of the first array of piezoelectric actuators 109 is a piezoelectric element. The piezoelectric element may have a length equal to 1 mm and a width equal to 0.5 mm. In some embodiments, the device 100 includes actuation circuitry (e.g., actuation circuitry 430 described with respect to FIG. 5) electrically coupled to the first array of piezoelectric actuators 109. In some embodiments, upon application of an electrical signal from the actuation circuitry, the first array of piezoelectric actuators 109 generates oscillations that create displacement as well as acoustic waves, which controls localized inertial movement of the particles in the fluid channel 102 in the three-dimensional x, y and z planes with sub-micron level control. In some embodiments, the first array of piezoelectric actuators 109 induces a laminar flow from the inlet 103 toward the outlet 104.

In some embodiments, the device 100 includes one or more pairs of electrodes 110 (e.g., a pair of electrodes). The one or more pairs of electrodes 110 may be used for charging particles flowing through the fluid channel 102 so that the particles can be manipulated with an electrical field. In some embodiments, the distance between a pair of the electrodes 110 is configured such that only a single cell is manipulated with an electrical field at a time. In some embodiments, the device 100 includes driver circuitry (e.g., driver circuitry 440 described with respect to FIG. 5) electrically coupled to the one or more pairs of electrodes 110. In some embodiments, the driver circuitry is configured to produce electrical signals in the megahertz and gigahertz frequency domains. In some embodiments, the frequency of the electrical signals provided to the one or more pairs of electrodes 110 depends on a type or types of the particles to be analyzed using the device 100.

In some embodiments, the output region 107 is divided into a plurality of output sub-regions (e.g., sub-regions 107-1 through 107-3) as shown in FIG. 1B. In some embodiments, each output sub-region having an outlet port and at least one of the first array of piezoelectric actuators 109. In this embodiment, each of different portions (e.g., each portion corresponding to a particular cell or a type of cell) of the sample fluid from the outlet 104 is deflected toward a corresponding output sub-region of the output region 107. As such, each of the different portions of the sample fluid is collected at and ejected from the corresponding output sub-region. The deflection of the different portions of the sample fluid may be achieved, for example, by the oscillations and displacement caused by the activation of the first array of piezoelectric actuators 109 (and/or other piezoelectric actuators implemented in or operationally associated with the device 100).

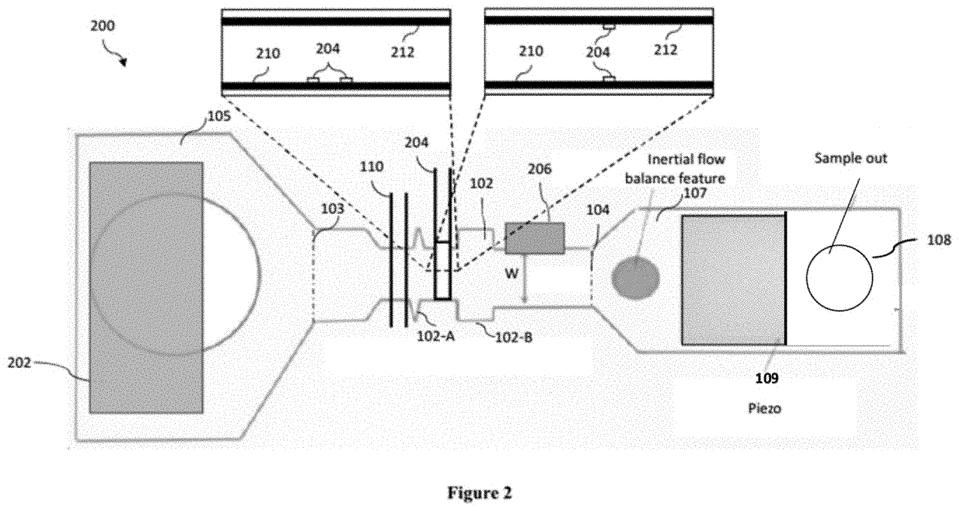

FIG. 2 shows a microfluidic device 200 in accordance with some embodiments. The device 200 is similar to the device 100 shown in FIG. 1A, except that the device 200 also includes a second array of piezoelectric actuators 202, one or more (pairs of) electrodes 204, and/or a third array of piezoelectric actuators 206. In some embodiments, the second array of piezoelectric actuators 202 is located adjacent to the inlet 103 for inducing a laminar flow from the inlet 103 toward the outlet 104. In some embodiments, the second array of piezoelectric actuators 202 is configured for sample input mixing and/or disassociation. In some embodiments, the second array of piezoelectric actuators 202 is located between the inlet 103 and the outlet 104. For example, the second array of piezoelectric actuators 202 may be located laterally between the inlet 103 and the outlet 104 (e.g., the inlet 103 may be located in an upstream region of the microfluidic channel, the outlet 104 may be located in a downstream region of the microfluidic channel, and the second array of piezoelectric actuators 202 may be located in a midstream region of the microfluidic channel). In some embodiments, the third array of piezoelectric actuators 206 is located between the inlet 103 and the outlet 104. Similar to the first array of piezoelectric actuators 109, in some embodiments, each of the second (202) and third (206) arrays of piezoelectric actuators includes one or more piezoelectric actuators (e.g., a piezo micro-electro-mechanical system (MEMS) actuator).

In some embodiments, upon application of an electrical signal from the actuation circuitry, the second array of piezoelectric actuators 202 generates oscillations that create displacement as well as acoustic waves which causes mixing and disassociation of the sample fluid and controls localized inertial movement of the particles to induce a laminar flow in the fluid channel 102. In some configurations, the sample fluid flows through the fluid channel 102 at a rate between 1 μL/min and 1 mL/min. In some embodiments, when activated using an appropriate electrical signal from the actuation circuitry, the third array of piezoelectric actuators 206 is configured for deflecting charged particles (which have been manipulated using an electrical field generated by the one or more pairs of electrodes 110 and/or the one or more pairs of electrodes 204) toward a specific output sub-region of the output region 107 (e.g., sub-region 107-1, 107-2, or 107-3 shown in FIG. 1B).

In some embodiments, the one or more pairs of electrodes 204 charge particles flowing through the fluid channel 102 so that the particles can be manipulated with an electrical field.

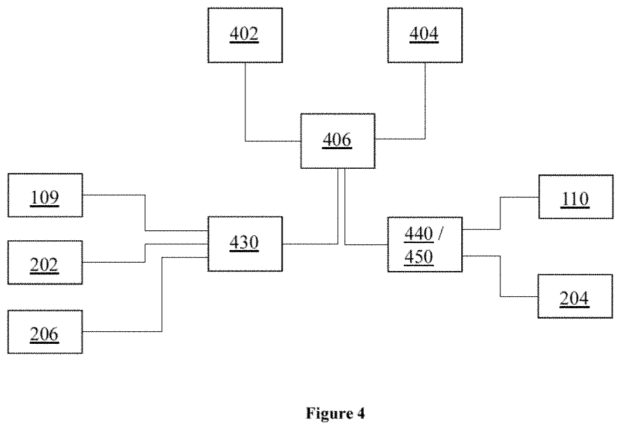

In some embodiments, the one or more pairs of electrodes 204 detect electrical signals of particles (e.g., cells) flowing through the microfluidic channel 102 adjacent to the one or more pairs of electrodes 204. In some embodiments, the driver circuitry is electrically coupled to the electrodes 204 and is configured to produce electrical signals in the megahertz and gigahertz frequency domains. In some embodiments, the frequency of the electrical signals provided to the electrodes 110 is in the megahertz domain and to the electrodes 204 is in the gigahertz domain. In some embodiments, the device 200 includes readout circuitry (e.g., readout circuitry 450 described with respect to FIG. 4) electrically coupled with one or more electrodes, such as the electrodes 110 and the electrodes 204. The readout circuitry receives electrical signals from the one or more electrodes 110 and 204 and relays the electrical signals (with or without processing, such as filtering, etc.) to one or more processors of, or operationally connected with, the device 200.

In some embodiments, the one or more pairs of electrodes 204 provide electrical fields for inducing movement (e.g., deflection) of charged particles (e.g., particles charged by the one or more pairs of electrodes 110). For example, the electrical fields provided by the one or more pairs of electrodes 204 may induce direct movement of the charged particles by providing a potential difference. As another example, the electrical fields provided by the one or more pairs of electrodes 204 may be used to control position, rotation and/or acceleration of the charged particles. Additionally or alternatively, the electrical fields provided by the one or more pairs of electrodes 204 may induce electrohydrodynamic flow of the fluid (e.g., when the fluid includes dielectric media).

In some embodiments, each particle may pass the vicinity of the one or more pairs of electrodes 110 for a period between 0.1 and 100 milliseconds. In some embodiments, each particle may pass the vicinity of the one or more pairs of electrodes 204 for a period between 0.1 and 100 milliseconds.

In some embodiments, a separation distance between a pair of electrodes 204 as well as a distance between the electrodes 110 and the electrodes 204 are configured based on a type or types of the particles to be analyzed using the device 100.

In some embodiments, the electrodes 110 and/or the electrodes 204 are located between the first array of piezoelectric actuators 109 and the second array of piezoelectric actuators 202. In some embodiments, the electrodes 110 and/or the electrodes 204 are located between the second array of piezoelectric actuators 202 and the third array of piezoelectric actuators 206.

In some embodiments, a particle processing rate in the microfluidic device 200 may be between from 100 particles per minute and 1 million particles per minute.

FIG. 2 also shows that, in some embodiments, the pair of electrodes 204 is located on a same substrate (e.g., substrate 210). In some embodiments, the pair of electrodes 204 is located on different substrates (e.g., one electrode of the pair of electrodes 204 is located on a bottom substrate 210 and the other electrode of the pair of electrodes 204 is located on a top substrate 212).

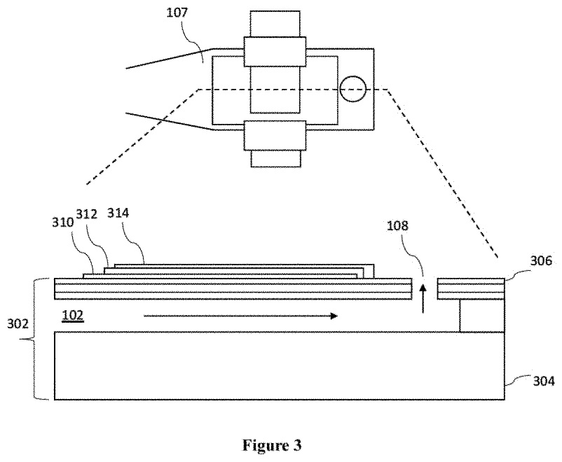

FIG. 3 is a cross-sectional view of the output region 107 of the device 200 in accordance with some embodiments. FIG. 3 shows a substrate 302 with the fluid channel 102. In some embodiments, the substrate 302 includes a first substrate portion 304 and a second substrate portion 306 separated from the first substrate portion 304 such that the fluid channel 102 is defined between the first substrate portion 304 and the second substrate portion 306. In some embodiments, the fluid channel 102 has a height between 10 microns and 1 mm (e.g., 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, or 1 mm, or within a range between any two of the aforementioned values). In some embodiments, the first substrate portion 304 has a thickness between 5 microns and 2 mm (e.g., 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1 mm, 1.1 mm, 1.2 mm, 1.3 mm, 1.4 mm, 1.5 mm, 1.6 mm, 1.7 mm, 1.8 mm, 1.9 mm, or 2 mm, or within a range between any two of the aforementioned values). In some embodiments, the second substrate portion 306 has a thickness between 5 microns and 200 microns (e.g., 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, or 200 microns, or within a range between any two of the aforementioned values).

In some embodiments, the first substrate portion 304 and the second substrate portion 306 are made of different distinct materials. For example, the first substrate portion is made of glass and the second substrate portion is made of silicon-on-insulator (SOI) semiconductor structure. In some embodiments, the first substrate portion is 500 microns thick. In some embodiments, the inlet 103 and/or the inlet port 106 is defined in the first substrate portion 304. In some embodiments, the outlet 104 and/or the outlet port 108 is defined in the second substrate portion 306. Further, in some embodiments, the first array of piezoelectric actuators 109 located in the output region 107 of the device 200 includes a layer of piezoelectric material 312 that is located over the second substrate portion 306, without overlapping with or covering any portion of the outlet 104 and/or the outlet port 108. In some embodiments, as shown in FIG. 3, the layer of piezoelectric material 312 is located between electrodes 310 and 314. In some embodiments, the layer of piezoelectric material 312 has a thickness between 0.1 microns and 100 microns (e.g., 0.1 microns, 0.5 microns, 1 microns, 2 microns, 5 microns, 10 microns, 20 microns, 30 microns, 40 microns, 50 microns, 60 microns, 70 microns, 80 microns, 90 microns, or 100 microns, or within a range between any two of the aforementioned values). In some embodiments, the inlet is defined in the second substrate portion.

Also shown in FIG. 3 is the outlet port 108. In some embodiments, the outlet port 108 has a diameter between 2 microns and 500 microns (e.g., 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, or 500 microns, or within a range between any two of the aforementioned values).

FIG. 4 is a block diagram illustrating electrical components for flow control of particles in a fluid channel in accordance with some embodiments. In some embodiments, the device (e.g., the device 100 or 200) includes one or more processors 402 and memory 404. In some embodiments, the memory 404 includes instructions for execution by the one or more processors 402. In some embodiments, the stored instructions include instructions for providing actuation signals to the first array of piezoelectric actuators 109, the second array of piezoelectric actuators 202, and/or the third array of piezoelectric actuators 206. In some embodiments, the actuation signals for the different arrays of piezoelectric actuators may be configured such that each array of piezoelectric actuators create oscillations at a different frequency from a frequency of oscillations of another array of piezoelectric actuators. For example, one or more of the first array of piezoelectric actuators 109, the second array of piezoelectric actuators 202, and the third array of piezoelectric actuators 206 may operate at a frequency in the range between 0.5 KHz and 100 KHz, for example, based on desired flow rates. In some embodiments, the stored instructions include instructions for providing actuation signals to the electrodes 110 and/or the electrodes 204 for charging particles flowing through the fluid channel 102 so that the particles can be manipulated with an electrical field.

In some embodiments, the device also includes an electrical interface 406 coupled with the one or more processors 402 and the memory 404.

In some embodiments, the device further includes actuation circuitry 430, which is coupled to one or more piezoelectric actuators, such as the first array of piezoelectric actuators 109, the second array of piezoelectric actuators 202, and the third array of piezoelectric actuators 206. The actuation circuitry 430 sends electrical signals to the one or more arrays of piezoelectric actuators 109, 202, 206 to initiate actuation of the one or more arrays of piezoelectric actuators.

In some embodiments, the device further includes driver circuitry 440, which is coupled to one or more electrodes, such as the electrodes 110 and the electrodes 204. The driver circuitry 440 sends electrical signals to the one or more electrodes 110, 204 to generate an electrical field using the one or more electrodes for charging particles flowing through the fluid channel 102.

In some embodiments, the device further includes readout circuitry 450, which is coupled to one or more electrodes, such as the electrodes 110 and the electrodes 204. The readout circuitry 450 receives electrical signals from the one or more electrodes 110, 204 and provides the electrical signals (with or without processing) to the one or more processors 402 via the electrical interface 406.

FIG. 5 is a flow diagram illustrating a method 500 of flow control of particles in a fluid channel in accordance with some embodiments.

The method 500 includes (510) providing a plurality of particles through a microfluidic channel having an outlet. For example, a sample fluid with particles (e.g., cells) is provided in the fluid channel 102 with the inlet 103 and the outlet 104. In some embodiments, the inlet port 106 is the inlet 103 and the outlet port 108 is the outlet 104 of the fluid channel 102.

In some embodiments, the method 500 includes (512) inducing, with a first array of piezoelectric actuators or a second array of piezoelectric actuators, a laminar flow from an inlet of the microfluidic channel toward the outlet. For example, the first array of piezoelectric actuators 109 may induce a laminar flow from the inlet 103 toward the outlet 104 of the fluid channel 102. As another example, the second array of piezoelectric actuators 202 located adjacent to the inlet 103 may induce a laminar flow from the inlet 103 toward the outlet 104 of the fluid channel 102. The first array of piezoelectric actuators 109 and/or the second array of piezoelectric actuators 202 may be activated or actuated based on actuation signals from the one or more processors 402.

In some embodiments, the method 500 includes (514) charging the particles flowing through the microfluidic channel so that the particles can be manipulated with an electrical field. For example, once activated, the electrodes 110 and/or the electrodes 204 charge the particles flowing through the fluid channel 102 so that the particles can be manipulated with an electrical field.

In some embodiments, the method 500 includes (516) providing actuation signals to one or more pairs of electrodes for charging the particles flowing through the microfluidic channel. For example, the one or more processors 402 provide actuation signals to the electrodes 110 and/or the electrodes 204 so that the particles in the fluid channel 102 can be manipulated with an electrical field.

In some embodiments, the method 500 includes (518) ejecting, with a first array of piezoelectric actuators located adjacent to the outlet, a portion of a fluid in the microfluidic channel. For example, once activated or actuated, the first array of piezoelectric actuators 109 causes displacement and oscillations for ejecting a portion of a fluid in the fluid channel 102 via the outlet port 108. In some embodiments, the method 500 includes (520) providing actuation signals to the first array of piezoelectric actuators (109), e.g., from the one or more processors 402.

Some embodiments may be described with respect to the following clauses.

Clause 1: A microfluidic device, comprising:

a substrate with a microfluidic channel having at least one outlet;

a first array of piezoelectric actuators located adjacent to the outlet for ejecting a portion of a fluid in the microfluidic channel; and

one or more pairs of electrodes for charging particles flowing through the microfluidic channel so that the particles can be manipulated with an electrical field.

Clause 2: The microfluidic device of clause 1, further comprising:

a second array of piezoelectric actuators.

Clause 3: The microfluidic device of clause 2, wherein:

the microfluidic channel has an inlet and the second array of piezoelectric actuators is located adjacent to the inlet.

Clause 4: The microfluidic device of clause 3, wherein:

the one or more pairs of electrodes are located between the first array of piezoelectric actuators and the second array of piezoelectric actuators.

Clause 5: The microfluidic device of clause 3 or 4, further comprising:

a third array of piezoelectric actuators located between the inlet and the at least one outlet.

Clause 6: The microfluidic device of clause 5, wherein:

the one or more pairs of electrodes are located between the second array of piezoelectric actuators and the third array of piezoelectric actuators.

Clause 7: The microfluidic device of clause 2, wherein:

the microfluidic channel has an inlet; and

the second array of piezoelectric actuators is located between the inlet and the at least one outlet.

Clause 8: The microfluidic device of any of clauses 1-7, wherein:

the substrate includes a first substrate portion separated from a second substrate portion, wherein the microfluidic channel is defined between the first substrate portion and the second substrate portion.

Clause 9: The microfluidic device of clause 8, wherein:

the first substrate portion is made of a first material and the second substrate portion is made of a second material that is distinct from the first material.

Clause 10: The microfluidic device of clause 8 or 9, wherein:

an outlet port of the outlet is defined in the second substrate portion.

Clause 11: The microfluidic device of any of clauses 8-10, wherein:

the microfluidic channel has an inlet, and

the inlet is defined in the first substrate portion.

Clause 12: The microfluidic device of any of clauses 8-11, wherein:

the first array of piezoelectric actuators includes a layer of piezoelectric material located over the second substrate portion without overlapping with any portion of an outlet port of the outlet.

Clause 13: The microfluidic device of any of clauses 1-12, further comprising:

one or more processors electrically coupled to the first array of piezoelectric actuators for providing actuation signals to the first array of piezoelectric actuators.

Clause 14: The microfluidic device of clause 13, wherein:

the one or more processors are configured to provide actuation signals to the one or more pairs of electrodes for charging particles flowing through the microfluidic channel so that the particles can be manipulated with an electrical field.

Clause 15: The microfluidic device of any of clauses 1-14, further comprising:

two or more pairs of electrodes for providing an electrical field so that the charged particles flowing through the microfluidic channel can be manipulated based on the electrical field.

Clause 16: The microfluidic device of any of clauses 1-15, wherein:

a first portion of the microfluidic channel has a first width and a second portion of the microfluidic channel has a second width that is greater than the first width.

Clause 17: A method, comprising:

providing a plurality of particles through a microfluidic channel having an outlet;

charging the particles flowing through the microfluidic channel so that the particles can be manipulated with an electrical field; and

ejecting, with a first array of piezoelectric actuators located adjacent to the outlet, a portion of a fluid in the microfluidic channel.

Clause 18: The method of clause 17, further comprising:

inducing, with the first array of piezoelectric actuators, a laminar flow from an inlet of the microfluidic channel toward the outlet.

Clause 19: The method of any of clauses 17-18, further comprising:

providing actuation signals to the first array of piezoelectric actuators.

Clause 20: The method of any of clauses 17-19, further comprising:

providing actuation signals to one or more pairs of electrodes for charging the particles flowing through the microfluidic channel so that the particles can be manipulated with an electrical field.

Clause 21: The method of any of clauses 17-19, further comprising:

providing actuation signals to two or more pairs of electrodes for charging the particles flowing through the microfluidic channel so that the particles can be manipulated with an electrical field.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the principles and the various described embodiments with various modifications as are suited to the particular use contemplated.

What is claimed is:

1. A microfluidic device, comprising:
a substrate with a microfluidic channel having at least one outlet;
a first array of piezoelectric actuators located adjacent to the outlet for ejecting a portion of a fluid in the microfluidic channel; and
one or more pairs of electrodes for charging particles flowing through the microfluidic channel so that the particles can be manipulated with an electrical field.

2. The microfluidic device of claim 1, further comprising:
a second array of piezoelectric actuators.

3. The microfluidic device of claim 2, wherein:
the microfluidic channel has an inlet, and the second array of piezoelectric actuators is located adjacent to the inlet.

4. The microfluidic device of claim 3, wherein:
the one or more pairs of electrodes are located between the first array of piezoelectric actuators and the second array of piezoelectric actuators.

5. The microfluidic device of claim 3, further comprising:
a third array of piezoelectric actuators located between the inlet and the at least one outlet.

6. The microfluidic device of claim 5, wherein:
the one or more pairs of electrodes are located between the second array of piezoelectric actuators and the third array of piezoelectric actuators.

7. The microfluidic device of claim 2, wherein:
the microfluidic channel has an inlet; and
the second array of piezoelectric actuators is located between the inlet and the at least one outlet.

8. The microfluidic device of claim 1, wherein:
the substrate includes a first substrate portion separated from a second substrate portion, wherein the microfluidic channel is defined between the first substrate portion and the second substrate portion.

9. The microfluidic device of claim 8, wherein:
the first substrate portion is made of a first material and the second substrate portion is made of a second material that is distinct from the first material.

10. The microfluidic device of claim 8, wherein:
an outlet port of the outlet is defined in the second substrate portion.

11. The microfluidic device of claim 8, wherein:
the microfluidic channel has an inlet, and
the inlet is defined in the first substrate portion.

12. The microfluidic device of claim 8, wherein:
the first array of piezoelectric actuators includes a layer of piezoelectric material located over the second substrate portion without overlapping with any portion of an outlet port of the outlet.

13. The microfluidic device of claim 1, further comprising:
one or more processors electrically coupled to the first array of piezoelectric actuators for providing actuation signals to the first array of piezoelectric actuators.

14. The microfluidic device of claim 13, wherein:
the one or more processors are configured to provide actuation signals to the one or more pairs of electrodes for charging particles flowing through the microfluidic channel so that the particles can be manipulated with an electrical field.

15. The microfluidic device of claim 1, further comprising:
two or more pairs of electrodes for providing an electrical field so that the charged particles flowing through the microfluidic channel can be manipulated based on the electrical field.

16. The microfluidic device of claim 1, wherein:
a first portion of the microfluidic channel has a first width and a second portion of the microfluidic channel has a second width that is greater than the first width.

17. A method, comprising:
providing a plurality of particles through a microfluidic channel having an outlet;
charging the particles flowing through the microfluidic channel so that the particles can be manipulated with an electrical field; and
ejecting, with a first array of piezoelectric actuators located adjacent to the outlet, a portion of a fluid in the microfluidic channel.

18. The method of claim 17, further comprising:
inducing, with the first array of piezoelectric actuators, a laminar flow from an inlet of the microfluidic channel toward the outlet.

19. The method of claim 17, further comprising at least one of:
providing actuation signals to the first array of piezoelectric actuators; or
providing actuation signals to one or more pairs of electrodes for charging the particles flowing through the microfluidic channel so that the particles can be manipulated with an electrical field.

20. The method of claim 17, further comprising:
providing actuation signals to two or more pairs of electrodes for charging the particles flowing through the microfluidic channel so that the particles can be manipulated with an electrical field.
